(19) United States
(12) Patent Application Publication
(10) Pub. No.: US 2020/0234288 A1
(43) Pub. Date: Jul. 23, 2020

(54) SYSTEMS AND METHODS OF SECURING SENSITIVE DATA

(71) Applicant: Leadpoint, Inc., Los Angeles, CA (US)

(72) Inventors: Marc L. Diana, Cornelius, NC (US); Jasjit S. Dhillon, Santa Barbara, CA (US)

(21) Appl. No.: 16/250,454

(22) Filed: Jan. 17, 2019

(51) Int. Cl. G06Q 20/38; G06Q 40/02; G06Q 20/42; G06Q 20/36; G06Q 20/08

(52) U.S. Cl. CPC G06Q 20/383; G06Q 40/025; G06Q 20/0855; G06Q 20/363; G06Q 20/42

(57) ABSTRACT

A system for securing sensitive data includes one or more databases, at least one processor, and a memory configured to store instructions. The one or more databases are configured to store a plurality of financial profiles and personally identifiable information corresponding to each user of the system. The instructions are operable when executed by the processor to receive a token from a financial institution and determine that the token corresponds to a first user of the system. The instructions are further operable when executed to communicate a credit application associated with the first user to the financial institution, wherein the credit application is generated based on a financial profile corresponding to the first user. The instructions are further operable when executed to automatically communicate, to the financial institution, personally identifiable information corresponding to the first user in response to determining that the first user accepted a credit offer of the financial institution.

### RELATED APPLICATION

This application claims priority to U.S. Provisional Patent Application Ser. No. 62/619,386, entitled Systems and Methods of Securing Sensitive Data, and filed on Jan. 19, 2018, which is hereby incorporated by reference.

### TECHNICAL FIELD

This disclosure relates in general to securing data, and more particularly, to systems and methods of securing personally identifiable information.

### BACKGROUND

Financial institutions (e.g., banks, lenders) generally require an applicant seeking credit to provide personally identifiable information (e.g., first and last name, social security number, residential address, and birth date) to the financial institution during the application process. The financial institution then requests financial information from one or more credit bureaus (e.g., EquiFax, TransUnion, & Experian) based on the personally identifiable information provided by the applicant. Although credit bureaus and financial institutions take measures to secure the sensitive data that they store (e.g., financial and personally identifiable information), credit bureaus and financial institutions remain regular targets for hackers and are therefore constantly at risk for data breach. In addition to external risk factors, credit bureaus and financial institutions may also take preventative measures to reduce the risk of internal data leaks or data spills. Irrespective of whether a breach is internal or external, the release of a person's sensitive information may be harmful. For example, a data breach victim may experience identity theft which may have both short and long term personal and financial consequences.

### SUMMARY OF THE DISCLOSURE

According to one embodiment, a system for securing sensitive data includes one or more databases, at least one processor, and a memory configured to store instructions. The one or more databases are configured to store a plurality of financial profiles and personally identifiable information corresponding to each user of the system. The instructions are operable when executed by the processor to receive a token from a financial institution and determine that the token corresponds to a first user of the system. The instructions are further operable when executed to communicate a credit application associated with the first user to the financial institution, wherein the credit application is generated based on a financial profile corresponding to the first user. The instructions are further operable when executed to automatically communicate, to the financial institution, personally identifiable information corresponding to the first user in response to determining that the first user accepted a credit offer of the financial institution.

Certain embodiments may provide one or more technical advantages. For example, an embodiment of the present disclosure provides increased protection of sensitive information relative to conventional systems and methods of applying for credit. Specifically, one or more embodiments of the present disclosure contemplate limiting the computing resources that receive sensitive information. As another example, an embodiment of the present disclosure provides for more limited and secure access to sensitive information relative to conventional systems and methods of applying for credit. In yet another example, an embodiment of the present disclosure provides a more efficient (conserving both time and computing resources) credit application process relative to conventional credit application processes. Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 is a block diagram illustrating an example of a network environment for a credit lending and application security platform (“CLASP”), according to one embodiment;

FIG. 2 is a block diagram illustrating an example of the credit and lending process using the CLASP of FIG. 1, according to some embodiments;

FIG. 3 is a flow chart illustrating a method of securing sensitive data using the CLASP of FIG. 1, according to one embodiment;

FIG. 4 is a block diagram illustrating an example computer system that may be used to implement the method of FIG. 3, according to certain embodiments;

FIG. 5 is a flow chart illustrating another method of securing sensitive data using the CLASP of FIG. 1, according to one embodiment; and

FIG. 6 is a flow chart illustrating yet another method of securing sensitive data using the CLASP of FIG. 1, according to one embodiment.

### DETAILED DESCRIPTION OF THE DISCLOSURE

Data breach is a serious concern for both organizations storing sensitive data (e.g., financial and/or personally identifiable information associated with a person) and persons associated with said confidential data. The release of confidential data is associated with a number of consequences, the most notable being identity theft. As an example, identity theft may result in financial fraud, leaving a data breach victim liable for debts incurred by a perpetrator. As another example, identity theft may result in personal fraud, which may in a particular instance, associate the data breach victim with non-financial crimes committed by the perpetrator. In addition to consequences endured by the person associated with the sensitive information, the organization storing such sensitive information may also experience repercussions as a result of a data breach. For example, the breached organization may be liable for the dissemination of a victim's sensitive information. As another example, the breached organization may provide damage control incentives and/or offerings to victims as a result of a data breach. In yet another example, the breached organization may come under criticism of the public and/or governmental/regulatory bodies. Because the dissemination of sensitive information has major consequences, security of such information is a major concern.

The conventional way of applying for credit (e.g., loans, credit cards) requires providing personally identifiable information to a credit lender or other financial institution which in turn seeks financial information about the applicant from a credit bureau based on the personally identifiable information provided by the applicant. As such, sensitive information about the applicant is known (and in some cases, stored) by both the credit bureau and the financial institution to which the applicant is requesting credit. This is the case even in situations where the financial institutions deny the applicant's request for credit. In such situation, applicant may proceed to request credit from one or more other financial institutions that will receive and request sensitive information associated with applicant. As a result, a number of financial institutions may gain access to sensitive information of the applicant. Because sensitive information is more secure in fewer hands than in more, such a process puts sensitive data at risk.

This disclosure recognizes that the above description of applying for credit may be overly simplistic in that many other parties may receive an applicant's sensitive data during the credit application and lending process. As an example, an applicant may not apply for credit directly with a financial institution and instead apply for credit via a third party lead generator (e.g., Mint.com), who in turn may send the applicant's sensitive data to one or more financial institutions that may or may not grant applicant's request for credit. Although the example used above refers to a third party lead generator, this disclosure recognizes that other middlemen may receive an applicant's sensitive data. In some cases, middlemen include data and content providers and/or affiliate marketing companies.

This disclosure recognizes a unique and unconventional method of securing sensitive data. Unlike the conventional method of applying for credit, this disclosure describes a method that disassociates an applicant's personally identifiable information from the applicant's financial information, which improves the security of the applicant's sensitive information. In such method, an applicant's personally identifiable information is released at an appropriate time in the application process (e.g., after an applicant has been approved for credit). As such, an applicant's personally identifiable information is not distributed and/or stored by parties with whom the applicant does not establish an ongoing financial relationship. Additionally, the method described herein secures financial information by limiting access to the applicant's financial information using duration-defined tokens (e.g., tokens being single time use only). By implementing one or more of steps disclosed herein, the security of the credit application and lending process is improved relative to the conventional application and lending process.

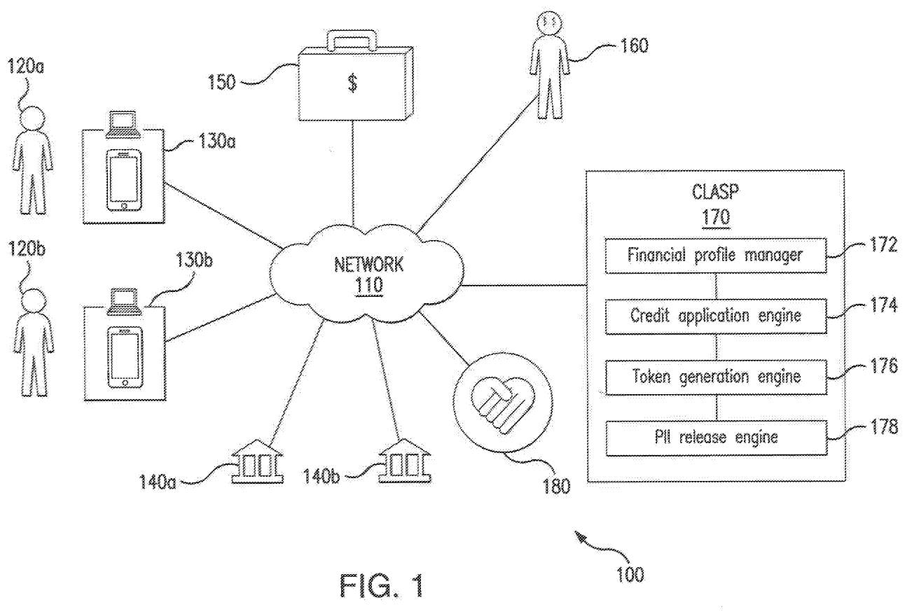

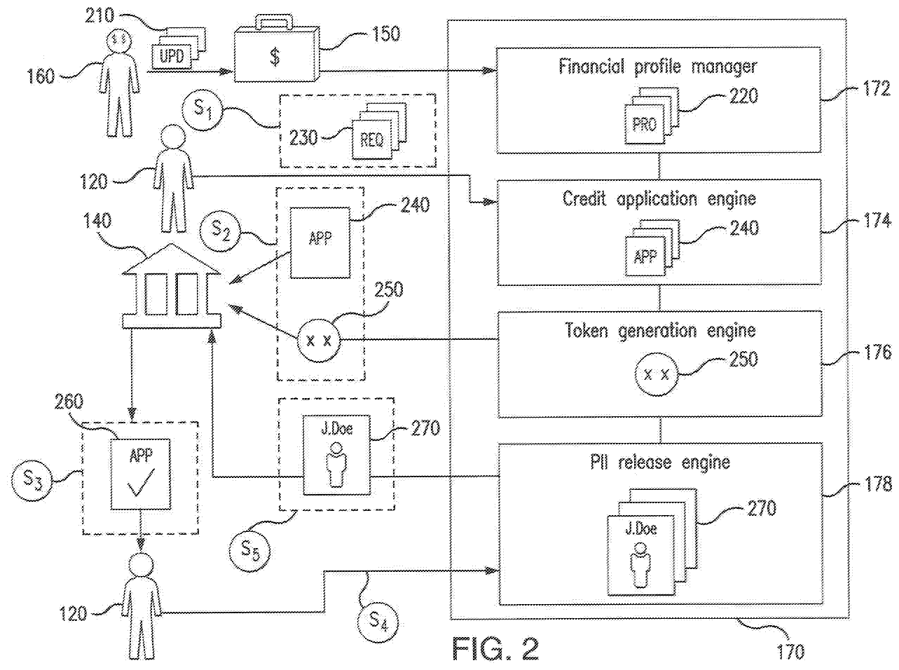

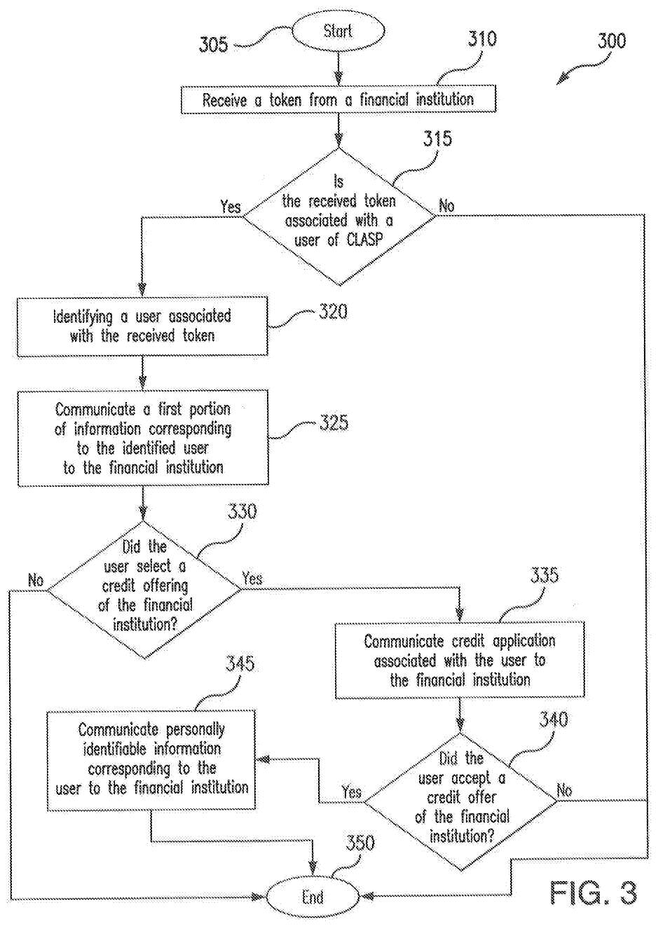

FIG. 1 illustrates a network environment for a credit application and lending platform. The network environment 100 may include a network 110, one or more users 120, one or more user devices 130, one or more financial institutions 140, one or more credit bureaus 150, one or more creditors 160, credit lending and application security platform (“CLASP”) 170, and one or more market intermediaries 180. In general, the teachings of this disclosure recognize systems and methods of securing sensitive data by using credit lending and application security platform 170 during the credit application and lending process. As will be further described in reference to FIG. 2, the components/entities of network environment 100 may communicate with one another over network 110 during the application and lending process.

Network 110 may refer to any interconnecting system capable of transmitting audio, video, signals, data, messages, or any combination of the preceding. Network 110 may include all or a portion of a public switched telephone network, a public or private data network, a local area network (LAN), an ad hoc network, a personal area network (PAN), a metropolitan area network (MAN), a wide area network (WAN), a local, regional, or global communication or computer network such as the Internet, an enterprise intranet, or any other suitable communication link, including combinations thereof. One or more portions of one or more of these networks may be wired or wireless. Examples of wireless networks 110 may include a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these.

Network environment 100 may include one or more users 120. As depicted in FIG. 1, network environment 100 includes two users 120a-b. Although this disclosure describes and depicts only two users, this disclosure recognizes that network environment 100 may include any suitable number of users 120. In some embodiments, users 120a-b are users of CLASP 170.

User 120 may be associated with one or more user devices 130. As depicted in FIG. 1, each user 120 is associated with two user devices 130. In some embodiments, user devices 130 are configured to access, over network 110, CLASP 170. As will be explained in further detail below in reference to FIG. 2, user 120 may utilize CLASP 170 to maintain a financial profile and/or to apply for credit from financial institutions 140. User 120 may prefer to use CLASP 170 when applying for credit over other conventional methods of doing so because CLASP 170 may offer various security advantages. For example, in one embodiment, CLASP 170 maintains a credit applicant's anonymity until applicant accepts a credit offer. This is in contrast to conventional application and lending processes that requires an applicant to disclose personally identifiable information in any initial credit application. As another example, CLASP 170 provides duration and identity limited access to an applicant's financial information. This is in contrast to conventional application and lending processes wherein an applicant's financial information is shared with one or more parties for an unlimited amount of time in connection with a single application for credit.

Network environment 140 may include one or more financial institutions 140. As depicted in FIG. 1, two financial institutions 140a-b are present in network environment 100. In some embodiments, financial institutions 140 are one or more of banks, credit card companies, mortgage companies, and loan providers. As used herein, financial institution 140 refers to any entity from which an applicant may seek credit and/or loans. Generally, financial institutions 140 may operate by extending credit to users 120 for a fee and pursuant to an agreement. Financial institutions 120 periodically report a user's compliance with such agreement to credit bureaus (e.g., credit bureau 150 of FIG. 1). As an example, financial institution 140a may report an unpaid balance of a credit card associated with user 120a to credit bureau 150 at the end of a billing cycle associated with user 120a.

As described above, network environment 100 may also include one or more credit bureaus 150, one or more creditors 160, and one or more market intermediaries 180. As depicted in FIG. 1, network environment 100 includes a single credit bureau 150, a single creditor 160, and a single market intermediary 180 (e.g., Lending Tree, Nerd Wallet). Credit organizations that collect financial information about debtors and provide the information to entities seeking information about the debtors. Generally, credit bureaus 150 collect financial information about debtors from creditors (e.g., creditors 160 of FIG. 1). Although FIG. 1 depicts creditor 160 communicating with credit bureau 150 over network 110, this disclosure recognizes that creditors 160 may communicate (or report) information to credit bureaus 150 in any suitable manner. As described above, the conventional credit application and lending process involves financial institution 140 requesting information about a credit applicant (e.g., user 120a) directly or indirectly from credit bureau 150. Credit bureau 150 then sends the requesting financial institution 140 a credit report associated with the credit applicant. Accordingly, at a minimum, financial institution 140 and credit bureau 150 have access to the credit applicant's sensitive data (both financial and personally identifiable data). As will be described in more detail below in reference to FIG. 2, the credit application and lending process disclosed herein eliminates the need for financial institutions 140 to request credit reports from credit bureaus 150. As a result, a credit applicant's sensitive data does not change hands unnecessarily and the credit application and lending process is more efficient.

As in conventional methods of credit application and lending processes, creditors 160 will report financial information related to users 120 to credit bureau 150, and credit bureau 150 will aggregate the received information and associate portions of the received information with one or more users 120. Unlike conventional methods of credit application and lending processes, this disclosure recognizes that credit bureaus 150 communicate some or all of the aggregated data to CLASP 170, which in turn uses the aggregated data to update financial profiles of users 120. Although credit bureaus 150 conventionally have access to personally identifiable information (PII) of users 120, this disclosure recognizes that credit bureaus 150 may only have access to financial information about anonymized users. In such embodiments, credit bureaus 150 may seek PII of users 120 from CLASP 170 using one or more secure methods described herein. For example, credit bureau 150 may request a token 250 from CLASP 170 associated with an anonymized user 120, and in response, CLASP 170 may send (or alternatively, provide access to) the requested PII.

As used herein, “creditor” describes an entity to whom user 120 owes money and a “potential creditor” describes an entity to whom user 120 may owe money. As an example, creditors may include landlords, utility companies, credit card companies, etc.

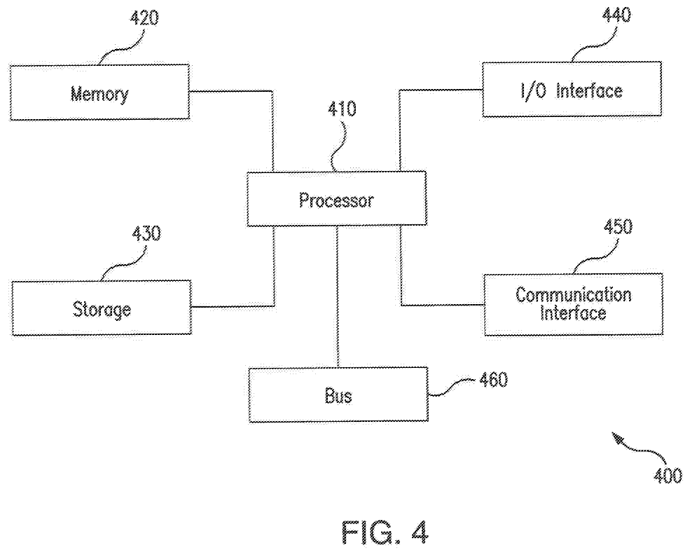

As will be described below in reference to FIG. 2, the credit application and lending process is more secure and a credit applicant's sensitive data is more secure when the credit applicant applies for credit using CLASP 170. CLASP 170 may, in some embodiments, be and/or include a computer such as computer 400 of FIG. 4. As such, CLASP 170 may include one or more components of a computer (e.g., computer 400 of FIG. 4). As depicted in FIG. 1, CLASP 170 includes a plurality of engines that, in some embodiments, comprise logic executable by a processor (e.g., processor 410 of FIG. 4). Such logic may be stored in a storage device (e.g., memory 420 and/or storage 430 of FIG. 4) and, when executed, may perform one, some, or all of the functionality described herein. As depicted in FIG. 1, CLASP 170 includes four engines: a financial profile manager 172, a credit application engine 174, a token generation engine 176, and a personally identifiable information (“PII”) release engine 178. Details of each of these engines will be described in more detail with respect to FIG. 2. Although this disclosure describes and depicts CLASP 170 including four particular engines, this disclosure recognizes that CLASP 170 may include more or less engines. In some embodiments, the engines of CLASP 170 may be communicably coupled such that the engines may exchange data between them. Additionally, CLASP 170 and its associated engines may include or be communicably coupled to one or more databases configured to store information (e.g., financial profiles 220 of FIG. 2, personally identifiable information 270 of FIG. 2).

Turning now to FIG. 2, FIG. 2 depicts an example of the credit and lending process using CLASP 170 of FIG. 1. Additionally, FIG. 2 shows example interactions between various elements of network environment 100 (e.g., users 120, financial institutions 140, credit bureaus 150, creditors 160, CLASP 170). For example, FIG. 2 depicts creditor 160 sending updates 210 to credit bureau 150. Updates 210 may include information about one or more debtors (e.g., users 120). As an example, updates 210 may include information about payments made to creditors 160 (e.g., on time payments and/or late payments), information about outstanding balances owed to creditors 160, information about purchases, information about loan terms, information about credit limits, information about account closures and/or information about charge-offs. Although this disclosure describes particular types of information that may comprise updates 210, updates 210 may comprise any suitable information that creditors 160 report to credit bureaus 150.

Upon receiving updates 210, credit bureau 150 may determine which updates 210 are applicable to which debtor. For example, credit bureau 150 may receive update 210a (not illustrated) and determine, based on the content of the update, that update 210a applies to user 120a. After determining that one or more updates 210 are applicable to a specific debtor, credit bureau 150 may aggregate data about the debtor. The aggregated data may include historical financial information about debtor and updates 210. In some embodiments, credit bureau 150 may generate one or more credit scores and/or one or more credit reports. As an example, Equifax may generate an Equifax credit score and a credit report based on financial information regarding user 120a. As another example, Experian may generate an Experian credit score and/or credit report based on financial information regarding user 120b.

Because credit bureaus 150 are conventionally the sole holders of this type of information, financial institutions 140 seek information about past, current, and potential debtors from credit bureaus 150. As described above, the information sought by financial institutions 140 may comprise sensitive information about a debtor, and relaying such information may jeopardize the security of the sensitive information. Accordingly, this disclosure recognizes users 120 controlling access to their respective financial and personally identifiable data, thereby increasing the security of such sensitive information. Users 120 may control access to their sensitive information using CLASP 170.

As illustrated in FIG. 2, CLASP 170 includes, in some embodiments, financial profile manager 172. Financial profile manager 172 is an engine of CLASP 170 that is configured to manage a plurality of financial profiles 220, each financial profile 220 corresponding to a specific user 120. Upon registering with CLASP 170, a financial profile 220 is established for user 120. The financial profile 220 established for user 120 includes some or all of the data aggregated by credit bureau 150. As such, financial profile manager 172 is configured to receive information about one or more debtors from one or more credit bureaus 150. In some embodiments, financial profile manager 172 stores financial profiles 220 internally (within a storage device associated with financial profile manager 172). In other embodiments, financial profile manager 172 stores financial profiles externally (within a storage device associated with CLASP 170).

Financial profile manager 172 is further configured to aggregate the data received about a particular user 120 and update the financial profile 220 corresponding to the particular user 120. Because the financial profile 220 generated by financial profile manager 172 may include financial data collected from one or more credit bureaus 150, the generated financial profile 220 may be a more accurate representation of a debtor's financial situation than the credit score and/or report generated by a single credit bureau 150. In some other embodiments, credit bureaus 150 are not the sole source of financial information of users 120. As an example, CLASP 170 may generate its own financial data regarding users 120 based on proprietary algorithms. As another example, CLASP 170 may use financial information provided by other credit sources (e.g., creditors 160). In some embodiments, financial profile manager 172 is further configured to send one or more financial profiles to credit application engine 174.

In some embodiments, access to a financial profile 220 is limited to the account holder (e.g., a user 120 having proper account credentials) and/or administrators of CLASP 170. As an example, access to financial profile 220a (not illustrated) which is associated with user 120a may be limited to user 120a and an administrator of CLASP 170.

CLASP 170 also includes credit application engine 174 in some embodiments. In some embodiments, credit application engine 174 is configured to perform one or more of the following actions: receive one or more application requests 230, identify a user 120 associated with a particular application request 230, receive a financial profile 220 associated with the user 120 corresponding to a particular application request 230, generate a credit application 240 that anonymizes the credit applicant, encrypt the generated credit application, and send the encrypted credit application 240 to one or more financial institutions 140 and/or other potential creditors. In some other embodiments, credit application engine 174 maintains a persistent credit application 240 for user 120 instead of generating credit application 240 based on request 230. In such an embodiment, credit application engine 174 continuously updates credit application 240 based on data received from credit bureaus 150.

As used herein, an “application request” 230 refers to a request 230 from a user 120 to generate a credit application. In some embodiments, credit application engine 174 receives one or more application requests 230 from one or more users 120. As depicted in FIG. 1, credit application engine 174 receives one application request 230 from user 120 at Step 1 (S₁). User 120 may send application request 230 in connection with a specific need such as a loan, mortgage, credit card, rental property, and/or any other suitable need. In some embodiments, request 230 includes information specifying a need and/or identifying one or more financial institutions to whom the generated application 240 should be directed.

In some embodiments, credit application engine 174 identifies user 120 based on the CLASP account used to generate such application request 230. For example, credit application engine 174 may determine that user 120a submitted application request 230a because application request 230a was sent from the CLASP account associated with user 120a. As another example, credit application engine 174 may identify user 120 based on information provided in request 230 (e.g., name, social security number, assigned user id, unique cryptographic number).

Upon identifying a user 120 associated with an application request 230, credit application engine 174 may receive the financial profile 220 associated with user 120. In some embodiments, credit application engine 174 receives financial profile 220 as a result of back and forth communications with financial profile manager 220 (e.g., credit application engine 174 requests financial profile 220 associated with user 120, financial profile manager 172 queries a database for the financial profile 220 associated with user 120 in response to receiving the request, financial profile manager 172 copies the financial profile 220 associated with user 120 and sends the copy of financial profile 220 to credit application engine 174). In other embodiments, credit application engine 174 may retrieve financial profile 220 associated with user 120 without requiring assistance of financial profile manager 172 (e.g., credit application engine 174 queries a database for the financial profile 220 associated with user 120 and copies the financial profile 220 associated with user 120). This disclosure recognizes that “receiving the financial profile 220” may include receiving either the original financial profile 220 and/or a copy of financial profile 220.

As described above, credit application engine 174 may further be configured to generate one or more credit applications 240. The generated credit applications 240 may include some or all of the information provided in application request 230 and/or the received financial profile 220. Credit application engine 174 is also configured to anonymize credit applications 240 such that the generated application 240 does not include any personally identifiable information 270 but does include one or more credit metrics. Generally, the generated credit application 240 includes only the information necessary for a financial institution (or other potential creditor) to make a determination as to whether a credit application 240 is approved or denied. As an example, credit application engine 174 may generate credit application 240a to include all information necessary for a bank to determine whether to lend funds to user 120a even though generated credit application 240a does not include data identifying user 120a personally. As another example, credit application engine 174 may generate credit application 240b to include all information necessary for a landlord to make a determination as to whether a potential tenant (e.g., user 120b) is financially suitable to lease a rental property.

In some embodiments, credit application engine 174 generates application 240 for review and/or input by user 120. As an example, user 120 may edit application 240 as necessary and ultimately approve sending of such application 240. As another example, user 120 may indicate to credit application engine 174 one or more financial institutions and/or other potential creditors to whom the generated application 240 should be sent.

Credit application engine 174 is also configured to encrypt the generated application 240 in some embodiments. This disclosure recognizes that encrypting the generated application 240 may limit access to the information included in generated application 240. In some embodiments, generated application 240 is encrypted using one or more tokens/keys 250 generated by token generation engine 250. For example, token generation engine 250 may generate a private token 250 and a corresponding public token 250 and send the private token 250 to credit application engine 174 to be used in the encryption of generated application 240. Additionally, token generation engine 176 may send the corresponding public token 250 to one or more recipients of generated application 240 (e.g., financial institutions 140 and/or other potential creditors 160). Recipients of generated application 240 may then use the corresponding public token 250 to decrypt generated application 240 to reveal the contents of generated application 240. Although this disclosure describes a particular method of encrypting and decrypting generated applications 240, this disclosure contemplates any suitable method of encrypting generated application 240 to limit access to the information included in generated application 240 to only authorized recipients.

After encrypting application 240, credit application engine 174 may send application 240 to one or more intended recipients (e.g., financial institutions 140 and/or other potential creditors 160). The sending of encrypted application 240 is indicated in FIG. 2 at Step 2(S₂). As described above, application recipients may be indicated by user 120 in request 230 and/or during a user review stage. Identifying recipients for application 240 may also be determined at any other suitable stage by credit application engine 174. As depicted in FIG. 2, generated application 240 is sent by credit application engine 174 to financial institution 140.

In some embodiments, credit application engine 174 may request token generation engine 176 to generate one or more tokens 250 in connection with credit application 240. Tokens 250 may be requested by credit application engine 174 automatically in response to generating application 240. Tokens 250 may also be requested by credit application engine 174 in response to user input.

As described above, CLASP 170 includes token generation engine 176 in some embodiments. Generally, token generation engine 176 is configured to generate one or more tokens 250 associated with credit applications 240. Tokens 250 generated by token generation engine may be limited in use and/or in duration. For example, tokens 250 may be one-time use keys that only allow the key to be used one time. As another example, tokens 250 may be keys that are only available for a specific time period (e.g., one hour, one day, one week). As detailed above, token generation engine 176 may generate a pair of tokens 250, a private token and a corresponding public token, for each credit application 240. Taking the example illustrated in FIG. 2, token generation engine 176 may provide a private token 250 to credit application engine 174 to encrypt credit application 240 and provide the corresponding public token 250 to financial institution 140, a recipient of credit application 240 selected by user 120.

In some embodiments, token generation engine 176 generates more than two tokens 250 per credit application 240. For example, token generation engine 176 may generate two public keys corresponding to a single private key for distribution to two separate financial institutions 140 that user 120 seeks mortgage rates from. As depicted in FIG. 2, public token 250 is sent to financial institution simultaneously with credit application 240 at Step 2 (S₂). This disclosure also recognizes that public token 250 may be sent by token generation engine 176 to a recipient (e.g., financial institutions 140 and/or other potential creditors) at a different time than credit application engine 174 sends credit application 240. As an example, token generation engine 176 may send token 250 to a credit application recipient at a time later than the time that credit application engine 174 sends credit application 240 to that recipient. As another example, token generation engine 176 may send token 250 to credit application recipient at a time earlier than the time that credit application engine 174 sends credit application 240 to that recipient.

As explained above, recipients of credit applications 240 generated by credit application engine 174 may use tokens 250 generated by token generation engine 176 to access the content of credit applications 240. Upon decrypting and analyzing the contents of credit applications 240, the recipients (e.g., financial institutions 140 and/or other potential creditors) may make approval determinations regarding credit applications 240 based on financial data included in credit applications 240. At this application determination stage, recipients are not provided any personally identifiable information. As such, recipient (e.g., financial institution 140 of FIG. 2) is not aware of the user 120 associated with credit application 240. The decision to approve or deny credit application 240 is based on the content of credit application 240 itself.

As indicated at Step 3 (S₃) in FIG. 2, a decision regarding credit application 240 is sent to user 120. As depicted in FIG. 2, financial institution 140 sends an approval credit decision 260 to user 120. In some embodiments, the credit decision 260 is indirectly sent to user 120 because financial institution 140 is not aware of the identity of user 120. For example, credit decision 260 may be sent to one or more engines of CLASP 170 (e.g., credit application engine 174) which in turn notifies user 120 of credit decision 260. Credit decisions 260 may, in some cases, include one or more credit offers and/or terms that financial institution 140 determines user 120 is eligible for. Although this disclosure describes specific information that credit decision 260 may include, this disclosure recognizes that credit decision 260 may include any suitable information.

Upon receiving credit decision 260, user 120 may determine to reveal personally identifiable information to financial institution 140. As an example, user 120 may reveal personally identifiable information to financial institution 140 when user 120 wishes to accept a credit offer presented by financial institution 140. As another example, user 120 may reveal personally identifiable information to financial institution 140 when user 120 wishes to move forward with loan processing based on terms provided in credit decision 260. As indicated in FIG. 2 at Step 4 (S₄), user 120 may notify one or more engines of CLASP 170 (e.g., PII release engine 178, credit application engine 174) that user 120 seeks to accept a credit offer associated with credit application 240. This disclosure uses “credit offer” to refer to any offers of potential lenders/creditors including credit cards, mortgages, loans, agreements (e.g., rental property agreements) and/or other similar offers.

As described above, CLASP 170 may include PII release engine 178 in some embodiments. Generally, PII release engine 178 is configured to manage personally identifiable information 270 for each user 120. In some embodiments, PII release engine 178 includes a database (not illustrated) storing personally identifiable information for each user 120. In other embodiments, PII release engine 178 is communicably coupled to a database (not illustrated) storing personally identifiable information for each user 120. The stored personally identifiable information may include one or more of names, social security numbers, passport numbers, bank account numbers, driver's license numbers, ethnicity, gender, credit/debit card numbers, and/or any other similar information.

In some embodiments, PII release engine 178 encrypts PII before storing in one or more databases associated with CLASP 170. In other embodiments, PII release engine 178 encrypts PII during communication/transmission within CLASP 170 and/or to entities outside CLASP 170 (e.g., network entities depicted in FIG. 1). In some embodiments, PII release engine 178 may, upon receiving PII associated with user 120, parse the received PII into one or more portions and distribute it to one or more databases associated with CLASP 170 for storage. In some cases, each portion of PII is stored in a cryptographically encrypted format. In some embodiments, PII release engine 178 is configured to re-assemble PII associated with a particular user 120 only upon receiving authorization from user 120 to share his/her respective PII (e.g., with a financial institution 140).

PII release engine 178 may further be configured to receive a request to provide personally identifiable information about user 120 to a particular entity. Such request may be generated by one or more engines of CLASP 170. For example, credit application engine 174 may generate such request in response to receiving a notification from user 120 that user 120 accepts a credit offer associated with credit application 240. In some embodiments, the request may include one or more of an identifier associated with user 120 (e.g., name, user id) and an identifier associated with the intended recipient of personally identifiable information 270 (e.g., name of financial institution 140, contact details for credit administrator associated with financial institution 140).

In response to receiving such request, PII release engine 178 may identify, in the database, personally identifiable information 270 corresponding to a particular user 120, make a copy the identified personally identifiable information 270, send the copy of the personally identifiable information 270 to the intended recipient (e.g., financial institution 140). In another embodiment, another engine of CLASP 170 is responsible for sending personally identifiable information 270 to the intended recipient. For example, PII release engine 178 may identify, in the database, personally identifiable information 270 corresponding to a particular user 120, make a copy the identified personally identifiable information 270, and send such copy to credit application engine 240 for relay to an intended recipient (e.g., financial institution 140). In yet another embodiment, one or more engines of CLASP 170 may send personally identifiable information 270 to user 120 who in turn relays personally identifiable information 270 to intended recipients such as financial institution 140. The release of personally identifiable information 270 to an intended recipient is depicted in FIG. 2 at Step 5 (S₅). In some embodiments, the intended recipient (e.g., financial institution 140) may use personally identifiable information 270 for completion of credit funding and/or loan documentation process.

This disclosure recognizes that personally identifiable information 270 may be securely communicated to intended recipients. In some embodiments, personally identifiable information 270 may be securely communicated in the same way that credit application 240 is communicated. For example, PII release engine 178 (or another engine of CLASP 170) may encrypt personally identifiable information 270 and token generation engine 250 may provide a corresponding token 250 (configured to decrypt personally identifiable information 270) to recipient of personally identifiable information 270.

Although FIG. 2 describes and depicts user 120 interacting only with CLASP 170 during the application lending and approval process, this disclosure also recognizes that user 120 may interact with other entities while also securing his/her sensitive data. For example, user 120 may receive a one-time use token 250 corresponding to a persistent credit application 240 associated with user 120 and provide the token 250 directly to a financial institution 140 (or other potential creditor (e.g., creditor 160)). In one such embodiment, user 120 requests generation of token 250 from token generation engine 176 and provides such token 250 to financial institution 140. In some instances, user 120 makes such request in response to receiving a notification from CLASP 170 that the persistent credit application 240 corresponding to user 120 is available. Token 250 may include an identifier of the financial profile 220 associated with user and/or the persistent credit application 240 associated with user 120. In either case, CLASP 170 may recognize user 120 associated with token 250 and send data about user 120's request for credit to financial institution 140. As an example, CLASP 170 may send minimum, anonymized information about user 120's request for credit (e.g., credit score, annual income) to financial institution 140 in response to receiving token 250 from financial institution 140. The information provided by CLASP 170 to financial institution 140 may include data indicating that user 120 is an existing customer of financial institution 140. In such example, financial institution 140 may use the information received from CLASP 170 to identify one or more credit offerings relevant to user 120. Financial institution 140 may then present the identified credit offerings to user 120 and, upon selection of an offering by user 120, CLASP 170 may release the persistent credit application 240 corresponding to user 120 to financial institution 140 so that financial institution 140 may determine whether to grant user 120's request for credit. In some embodiments, financial institution 140 provides a credit offer to user 120 which user may choose to accept or reject. If user 120 accepts the credit offer, CLASP 170 may provide personally identifiable information 270 to financial institution 140 to complete the credit application and fulfilment process. As described above, credit application 240 and/or personally identifiable information 270 may be securely communicated to financial institution using additional tokens 250 that may be generated by token generation engine 250.

This disclosure also recognizes a more expedited process in which CLASP 170 sends persistent credit application 240 associated with user 120 to financial institution 140 in response to receiving token 250 from financial institution 140 (rather than sending minimum, anonymized information). Financial institution 140 may then analyze persistent credit application 240 to provide credit offerings to user 120. In some embodiments, user 120 selection of one of the presented credit offerings authorizes CLASP 170 to send persistent credit application 240 to the financial institution 140 associated with the credit offering.

Although the above examples describe user 120 interacting directly with financial institution or another potential creditor, this disclosure recognizes that user 120 may also interact with a third party such as a market intermediary (e.g., Lending Tree, Nerd Wallet) 180. In such case, user 120 may identify one or more financial offerings via a website associated with a market intermediary 180 by performing a web search using a search engine. Upon selecting an offer identified through a website of market intermediary 180, user 120 may be forwarded to a webpage (or other interface) associated with CLASP 170, wherein user 120 is prompted to login to, or register with, CLASP 170. In some embodiments, user 120 provides his/her PII to CLASP 170 and CLASP 170 stores the provided PII for user 120 as described above. CLASP 170 may be further configured to query credit sources (e.g., credit bureaus 150, financial institutions 140, creditors 160), based on PII provided by user 120 to CLASP 170, in order to obtain financial information regarding user 120. As discussed above, one or more engines of CLASP 170 may generate additional data (e.g., financial profiles, persistent credit applications) based on the PII received from user 120 and/or the final information received from credit sources. In some embodiments, CLASP 170 is further configured to perform other desirable operations such as ranking users 120 170 by credit score.

In some instances, CLASP 170 notifies user 120 when his/her respective persistent credit application becomes available and sends, to user 120, a one-time use token 250 corresponding to his/her respective persistent credit application 240. User 120 may provide the received token 250 directly to the third party at his/her discretion. Upon receiving token 250 from the third party, CLASP 170 may recognize user 120 associated with token 250 and send data about user 120's request for credit to the third party. As an example, CLASP 170 may send minimum, anonymized information about user 120's request for credit (e.g., credit score, annual income) to the third party in response to receiving token 250 from the third party. Third party may then use the information received from CLASP 170 to identify one or more credit offerings relevant to user 120. In some embodiments, the credit offerings identified by the third party includes one or more offerings from one or more financial institutions 140. In some embodiments, CLASP 170 provides additional tokens 250 to the third party for forwarding to the financial institutions 140 associated with offerings selected by the third party and/or user 120. For example, upon third party identification of two good offers (e.g., a first offering associated with financial institution 140a and a second offering associated with financial institution 140b), CLASP 170 may send two additional tokens 250 to the third party that are in turn sent to financial institution 140a and financial institution 140b. Financial institutions 140a-b may then use the tokens to request minimum, anonymized data, and/or credit applications 240 from CLASP 170 in order to provide formal offerings to user 120. In some embodiments, financial institution 140a-b may determine, based on credit application 240, whether to approve user 120's request for credit and provide an offer 260 to user 120. If financial institution 140b approves the request for credit and if user 120 accepts offer 206, CLASP 170 may release personally identifiable information 270 associated with user 120 to financial institution 140b so financial institution 140b can complete the lending and credit provisioning process. As discussed above, PII may be accessed by way of tokens 250. For example, CLASP 170 may send a token 250 to financial institution 140 in response to determining that user 120 accepted an offer of financial institution 140. Financial institution 140 may then present such token 250 to CLASP 170 in order to access PII of user 120. As another example, user 120 may request CLASP to send token 250 to user (or financial institution 140) upon selecting an offer of financial institution 140. If token 250 is sent to user 120, user 120 may provide token 250 to financial institution 140 such that financial institution 140 may present such token 250 to CLASP 170 to gain access to PII of user 120.

Financial institution 140 may then present the identified credit offerings to user 120 and, upon selection of an offering by user 120, CLASP 170 may provide personally identifiable information (PII) 270 to financial institution 140a so that financial institution 140a can complete the lending and credit provisioning process. As described above, credit application 240 and/or personally identifiable information 270 may be securely communicated to financial institution using additional tokens 250 that may be generated by token generation engine 250.

Although this disclosure describes and depicts utilizing tokens 250 in a particular manner in order to secure sensitive information about user 120 (e.g., gaining access to a persistent credit application 240 in response to presenting token 250 to CLASP 170), one of ordinary skill will recognize other manners of doing so. For example, an interested party (e.g., market intermediary 180, financial institution 140) may receive a secondary token in response to providing CLASP 170 with the token 250 received from user 120 (i.e., primary token). The interested party may then provide secondary token 250 to CLASP 170 in order to obtain access to the persistent credit application 240 corresponding to user 120. For the avoidance of doubt, secondary token 250 may be generated by token generation engine 176. This manner may be preferred as it further secures sensitive information about user 120.

This disclosure also recognizes various benefits of allowing persons/entities to purchase tokens 250. As described above, tokens 250 may facilitate access to sensitive data. Accordingly, some persons/entities may wish to purchase tokens 250 to proactively gain access to sensitive data. As used herein, the person/entity that purchases one or more tokens 250 is referred to as a “token holder.” In some embodiments, token holders may be users 120. In other embodiments, third parties such as financial institutions 140, market intermediaries (e.g., market intermediaries 180 of FIG. 1), and/or insurance companies may be token holders. Although specific types of third parties have been described, this disclosure recognizes that any suitable and/or interested third party may be a token holder. Token holders may use tokens 250 to access information to user information stored by CLASP 170. As an example, token holders may use token(s) 250 to purchase access to credit applications 240 and/or personally identifiable information 270. As another example, token holders may use token(s) 250 to purchase access to credit interests of users 120 (e.g., user 120 indicates to CLASP 170 an interest to receive mortgage and/or loan offerings) and/or underwriting data. In yet another example, token holders may use token(s) 250 to purchase access to verification and/or validation data to verify/validate data about user 120.

In addition to using tokens 250 to purchase access to information, tokens 250 may also be used to trade for other products/services within the financial community. As an example, tokens 250 may be used to purchase one or more bundles of consumer debt. This disclosure also recognizes that token holders may, in some cases, realize tax benefits to holding tokens 250. Such tax benefit may be maintained unless and until tokens are redeemed for fiat currency.

This disclosure also recognizes the benefits of using blockchain technology to secure transactions involving tokens 250. For example, all credit profile and credit application generation transactions, as well as all token transactions related to a consumer's credit requests, may be recorded permanently in CLASP's proprietary blockchain master distributed ledger. Thus, CLASP 170 may be a business-ready blockchain platform which adds a fundamental class of functionality to blockchain in the form of programmable personal identity, credit history, credit applications, and financial contract artifacts—all managed by CLASP 170. CLASP 170 may enable credit requesters (e.g., users 120) and lenders (e.g., financial institutions 140) to perform computation across information related to these artifacts for the purpose of securely sharing personally identifiable information (PII) in the context of applying for credit and the granting credit, in a cryptographically secure manner. CLASP 170 may facilitate the execution of identity sharing and credit access use cases that is not possible on existing blockchains. In some embodiments, CLASP 170 includes a decentralized, private, network of peer-to-peer computer nodes comprising of members of CLASP 170 (e.g., users 120). Members of CLASP 170 (e.g., users 120) may store a decentralized ledger and support the computation required to enable the secure sharing and validation of transactions related to leveraging personally identifiable information to apply for credit, the verification of credit history, and the granting of credit.

In addition to controlling the generation of tokens 250, CLASP 170 may also control availability of tokens 250. As an example, CLASP 170 may limit the number of tokens 250 available at any one moment to 200,000. Additionally, CLASP 170 may determine monetary value (if any) associated with tokens 250. In some embodiments, value of tokens 250 is established when tokens are generated/released. In other cases monetary value might be established via trading of tokens on the top ten cryptocurrency exchanges.

FIG. 3 is a flow chart illustrating a method 300 of securing sensitive data using the CLASP of FIG. 1, according to one embodiment. One or more engines of CLASP 170 may perform one or more of the steps of method 300. The method 300 begins in a step 305 and continues to a step 310.

At step 310, CLASP receives a token 250 from a third party. In some embodiments, the third party is a financial institution 140. Token 250 may correspond to a user of CLASP 170. For example, token 250 may be the same token generated by CLASP 170 (e.g., token generation engine 250) and provided to a particular user 120 upon request. User 120 may, in turn, provide token 250 to a third party in order for third party to access information about user 120 (e.g., minimum, anonymized information). As such, token 250 may comprise an identifier of a user of CLASP 170. For example, token 250 may include an identifier corresponding to user 120a. In some embodiments, the method 300 continues to a step 315.

At step 315, CLASP 170 determines whether token 250 is associated with a user of CLASP 170. In some embodiments, CLASP 170 performs this step by analyzing token 250 for an identifier, and if token 250 includes an identifier, comparing such identifier to identifiers of user 120. If at step 315 CLASP determines that token 250 is associated with a user 120 of CLASP 170, the method proceeds to a step 320. In contrast, if at step 315 CLASP 170 determines that token 250 is not associated with a user 120 of CLASP 170, the method proceeds to end step 350.

As step 320, CLASP 170 identifies a user associated with token 250. As an example, CLASP 170 may determine, based on the identifier of token 250, that token 250 corresponds to user 120a. As another example, CLASP 170 may determine, based on the identifier of token 250, that token 250 corresponds to user 120b. This disclosure recognizes that each token may, at most, correspond to one user 120 of CLASP 170. After identifying a user 120 of CLASP 170 associated with token 170, the method 300 proceeds to a step 325.

At step 325, CLASP 170 communicates a first portion of information corresponding to user 120 to the third party. As depicted in FIG. 3, CLASP 170 communicates the first portion of information to financial institution 140. In some embodiments, the first portion of information may include minimum, anonymized information about a user 120's request for credit. As an example, the first portion of information may be or include a credit score associated with user 120 and/or annual income associated with user 120. Although this disclosure describes specific types of information that this first portion of information may include, this disclosure recognizes that first portion of information may be or include any suitable information that permits a third party to generate credit offerings or promotions for user 120. After communicating the first portion of information to the third party, the method 300 proceeds to a step 330.

At step 330, CLASP 170 determines whether user 120 selected a credit offering and/or promotion offered by the third party. As depicted in FIG. 3, CLASP 170 determines whether user 120 selects a credit offering of financial institution 140. In some embodiments, CLASP 170 determines that user 120 selected a credit offering and/or promotion of financial institution 140 based on CLASP 170 receiving a notification from user 120 and/or financial institution 140. Although a specific manner of determining whether user 120 has selected a credit offering has been described, this disclosure recognizes any suitable manner of determining whether user 120 has selected a credit offering of a third party and/or financial institution 140. In some embodiments, CLASP 170 automatically communicates a credit application 240 associated with user 120 to financial institution 140 in response to determining that user 120 has selected a credit offering of a third party. In other words, if at step 330 CLASP 170 determines that user 120 selected a credit offering of financial institution 140, method 300 proceeds to step 335. In contrast, if at step 330 CLASP 170 determines that user 120 did not select a credit offering of financial institution 140, method 300 proceeds to end step 350.

At step 335, CLASP 170 communicates a credit application 240 to a third party. As illustrated in FIG. 3, CLASP 170 communicates credit application 240 associated with user 120 to financial institution 140. As described herein, CLASP 170 may maintain an updated version of each user's credit application for distribution to authorized third parties. Thus, upon determining that user 120 selected a particular offering from a particular financial institution, CLASP 170 may communicate the persistent credit application 140 associated with the user that selected the credit offering to the financial institution 140 providing the credit offering. Upon receiving credit application 240, financial institution may use the information contained in credit application 240 to analyze and in some cases, prepare credit offers for user 120. As an example, financial institution 140a may use the information contained in credit application 240 associated with user 120a to prepare a mortgage offer for user 120a. In some cases, financial institution 140 may present such credit offers to user 120. In some embodiments, the method 300 proceeds to step 340 after communicating credit application 240 to the third party.

At step 340, CLASP 170 determines whether user 120 accepts a credit offer associated with the third party. As illustrated, CLASP 170 determines whether user 120 accepts a credit offer of financial institution 140. If user 120 rejects credit offers of financial institution 140, the method 300 proceeds to end step 350. Alternatively, if user 120 accepts at least one credit offer of financial institution 140 at step 340, the method 300 may proceed to step 345 at which point CLASP 170 communicates personally identifiable information 270 to the financial institution 140. After communicating personally identifiable information 270 to financial institution, the method 300 may proceed to end step 350.

FIG. 4 is a block diagram illustrating an example computer system 400 that may be used to implement the method of FIG. 3, according to certain embodiments. As is described above, the functionality of CLASP 170 may be programmable instructions configured to be implemented by a processor of computer system 400. Computer system 400 may be any suitable computing system in any suitable physical form. In some embodiments, computer system 400 may be device 130. As example and not by way of limitation, computer system 400 may be a virtual machine (VM), an embedded computer system, a system-on-chip (SOC), a single-board computer system (SBC) (e.g., a computer-on-module (COM) or system-on-module (SOM)), a desktop computer system, a laptop or notebook computer system, a mainframe, a mesh of computer systems, a server, an application server, or a combination of two or more of these. Where appropriate, computer system 400 may include one or more computer systems 400; be unitary or distributed; span multiple locations; span multiple machines; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate. Some or all of the steps of the methods described herein may be performed automatically. Additionally, this disclosure describes various functionalities of CLASP 170 that may be performed automatically. This disclosure recognizes that the automatic performance of such steps and/or functionalities may be associated with benefits such as a reduction in CPU resources, memory resources, and network bandwidth that would otherwise be required to perform these actions.

One or more computer systems 400, including user device 130, may perform one or more steps of one or more methods described or illustrated herein. As described above, user device 130 or another computer system 400 may perform all or some of the steps of the methods described herein (e.g., method 300 of FIG. 3). In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As an example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

Computer system 400 may include a processor 410, memory 420, storage 430, an input/output (I/O) interface 440, a communication interface 450, and a bus 460 in some embodiments, such as depicted in FIG. 4. Although this disclosure describes and illustrates a particular computer system having a particular number of particular components in a particular arrangement, this disclosure contemplates any suitable computer system having any suitable number of any suitable components in any suitable arrangement.

Processor 410 includes hardware, software, or both for executing instructions, such as those making up a computer program, in particular embodiments. For example, processor 410 may execute CLASP 170 to secure sensitive data. As an example and not by way of limitation, to execute instructions, processor 410 may retrieve (or fetch) the instructions from an internal register, an internal cache, memory 420, or storage 430; decode and execute them; and then write one or more results to an internal register, an internal cache, memory 420, or storage 430. In particular embodiments, processor 410 may include one or more internal caches for data, instructions, or addresses. This disclosure contemplates processor 410 including any suitable number of any suitable internal caches, where appropriate. As an example and not by way of limitation, processor 410 may include one or more instruction caches, one or more data caches, and one or more translation lookaside buffers (TLBs). Instructions in the instruction caches may be copies of instructions in memory 420 or storage 430, and the instruction caches may speed up retrieval of those instructions by processor 410. Data in the data caches may be copies of data in memory 420 or storage 430 for instructions executing at processor 410 to operate on; the results of previous instructions executed at processor 410 for access by subsequent instructions executing at processor 410 or for writing to memory 420 or storage 430; or other suitable data. The data caches may speed up read or write operations by processor 410. The TLBs may speed up virtual-address translation for processor 410. In particular embodiments, processor 410 may include one or more internal registers for data, instructions, or addresses. This disclosure contemplates processor 410 including any suitable number of any suitable internal registers, where appropriate. Where appropriate, processor 410 may include one or more arithmetic logic units (ALUs); be a multi-core processor; or include one or more processors. Although this disclosure describes and illustrates a particular processor, this disclosure contemplates any suitable processor.

Memory 420 may include main memory for storing instructions for processor 410 to execute or data for processor 410 to operate on. As an example and not by way of limitation, computer system 400 may load instructions from storage 430 or another source (such as, for example, another computer system 400) to memory 420. Processor 410 may then load the instructions from memory 420 to an internal register or internal cache. To execute the instructions, processor 410 may retrieve the instructions from the internal register or internal cache and decode them. During or after execution of the instructions, processor 410 may write one or more results (which may be intermediate or final results) to the internal register or internal cache. Processor 410 may then write one or more of those results to memory 420. In particular embodiments, processor 410 executes only instructions in one or more internal registers or internal caches or in memory 420 (as opposed to storage 430 or elsewhere) and operates only on data in one or more internal registers or internal caches or in memory 420 (as opposed to storage 430 or elsewhere). One or more memory buses (which may each include an address bus and a data bus) may couple processor 410 to memory 420. Bus 460 may include one or more memory buses, as described below. In particular embodiments, one or more memory management units (MMUs) reside between processor 410 and memory 420 and facilitate accesses to memory 420 requested by processor 410. In particular embodiments, memory 420 includes random access memory (RAM). This RAM may be volatile memory. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 420 may include one or more memories 180, where appropriate. Although this disclosure describes and illustrates particular memory, this disclosure contemplates any suitable memory.

Storage 430 may include mass storage for data or instructions. As an example and not by way of limitation, storage 430 may include a hard disk drive (HDD), a floppy disk drive, flash memory, an optical disc, a magneto-optical disc, magnetic tape, or a Universal Serial Bus (USB) drive or a combination of two or more of these. Storage 430 may include removable or non-removable (or fixed) media, where appropriate. Storage 430 may be internal or external to computer system 400, where appropriate. In particular embodiments, storage 430 is non-volatile, solid-state memory. In particular embodiments, storage 430 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 430 taking any suitable physical form. Storage 430 may include one or more storage control units facilitating communication between processor 410 and storage 430, where appropriate. Where appropriate, storage 430 may include one or more storages 140. Although this disclosure describes and illustrates particular storage, this disclosure contemplates any suitable storage.

I/O interface 440 may include hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 185 for them. Where appropriate, I/O interface 440 may include one or more device or software drivers enabling processor 410 to drive one or more of these I/O devices. I/O interface 440 may include one or more I/O interfaces 185, where appropriate. Although this disclosure describes and illustrates a particular I/O interface, this disclosure contemplates any suitable I/O interface.

Communication interface 450 may include hardware, software, or both providing one or more interfaces for communication (such as, for example, packet-based communication) between computer system 400 and one or more other computer systems 400 or one or more networks (e.g., network 110). As an example and not by way of limitation, communication interface 450 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 450 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 450 for any of these networks, where appropriate. Communication interface 450 may include one or more communication interfaces 190, where appropriate. Although this disclosure describes and illustrates a particular communication interface, this disclosure contemplates any suitable communication interface.

Bus 460 may include hardware, software, or both coupling components of computer system 400 to each other. As an example and not by way of limitation, bus 460 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 460 may include one or more buses 460, where appropriate. Although this disclosure describes and illustrates a particular bus, this disclosure contemplates any suitable bus or interconnect.

The components of computer system 400 may be integrated or separated. In some embodiments, components of computer system 400 may each be housed within a single chassis. The operations of computer system 400 may be performed by more, fewer, or other components. Additionally, operations of computer system 400 may be performed using any suitable logic that may comprise software, hardware, other logic, or any suitable combination of the preceding.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

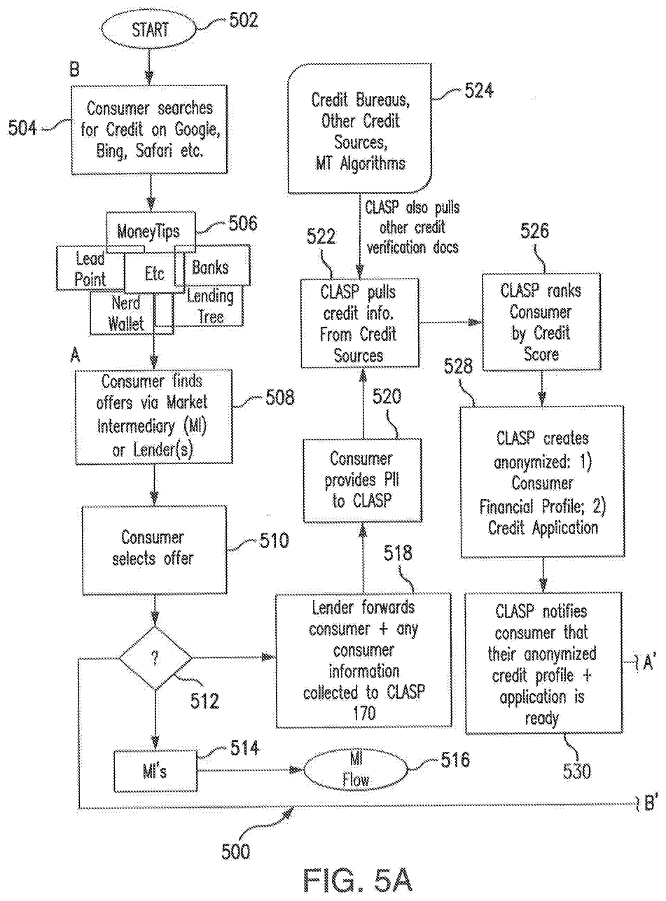

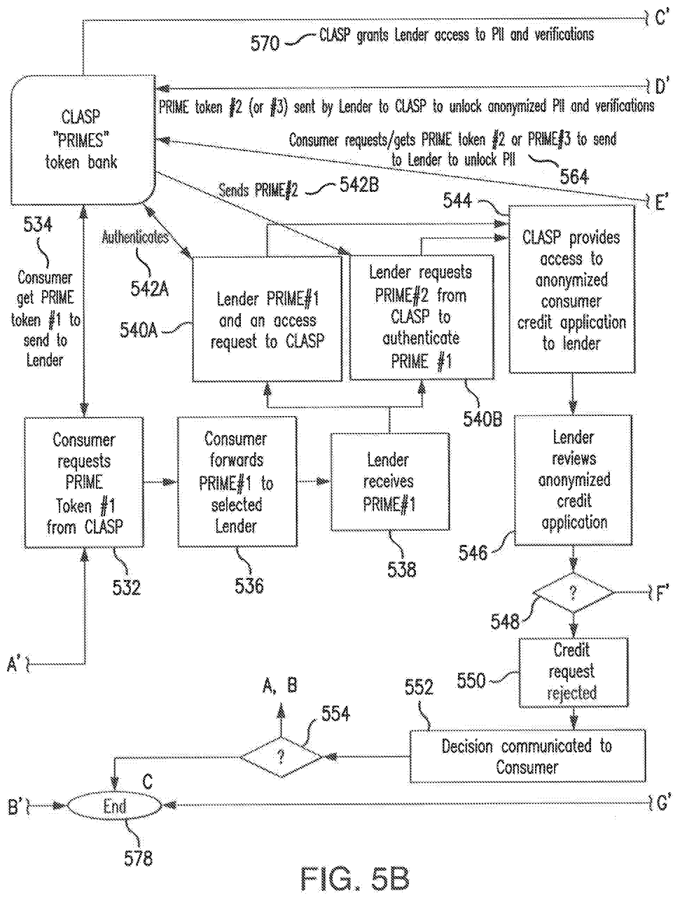

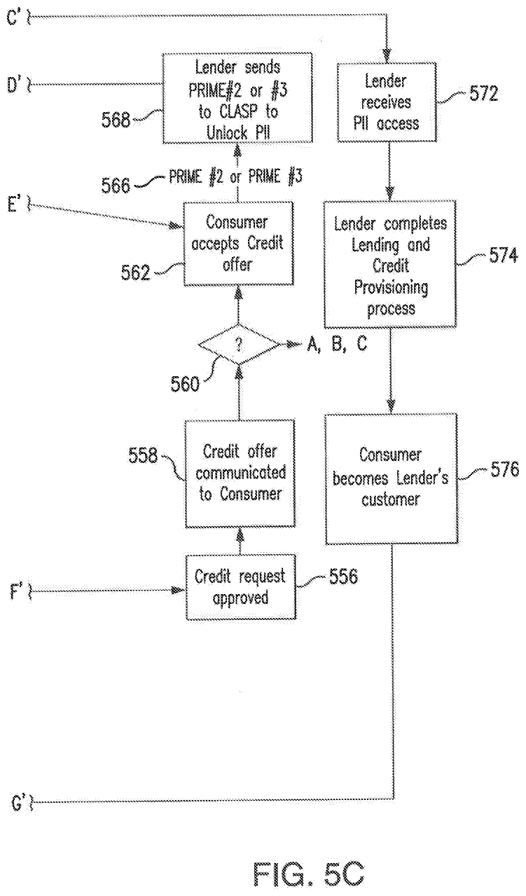

Turning now to FIG. 5, FIG. 5 illustrates a method 500 of securing sensitive data using CLASP 170. Generally, FIG. 5 illustrates a method flow wherein the credit application and lending process is initiated by a lender (e.g., financial institution 140). Although method 500 is depicted as including a number of steps, this disclosure recognizes other embodiments of method 500 that includes only one, some, or all of the steps of method 500. One or more of the steps of method 500 may be stored to a computer-readable medium (e.g., memory 420 and/or storage 430 of FIG. 4), which may be executed by a processor (e.g., processor 410 of FIG. 4).

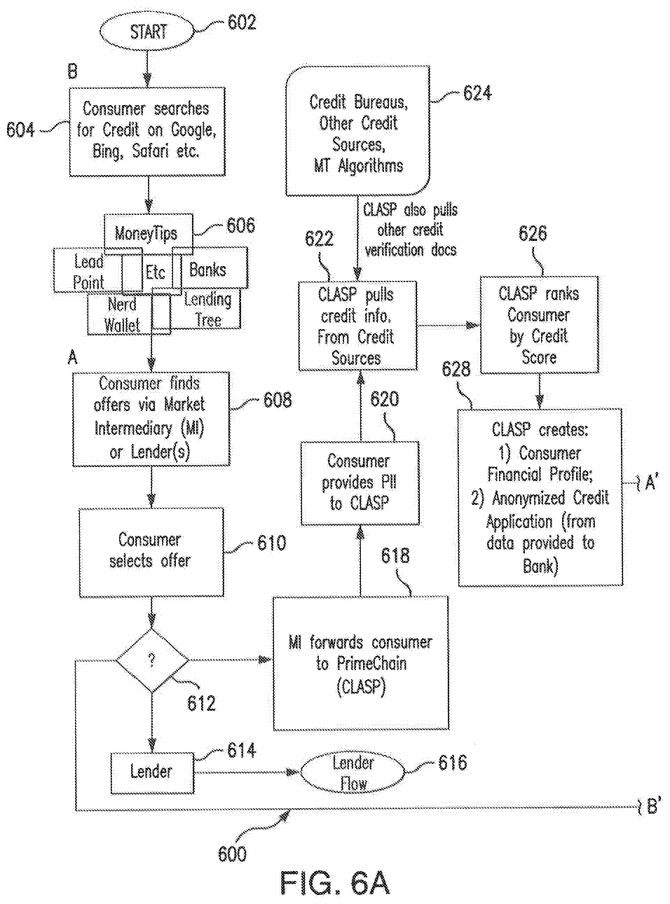

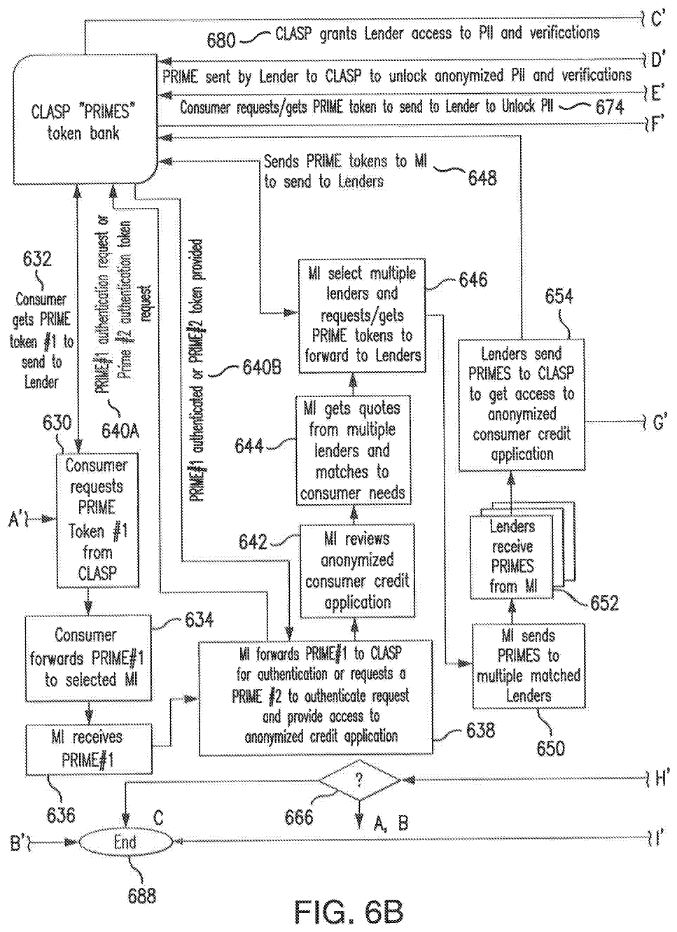

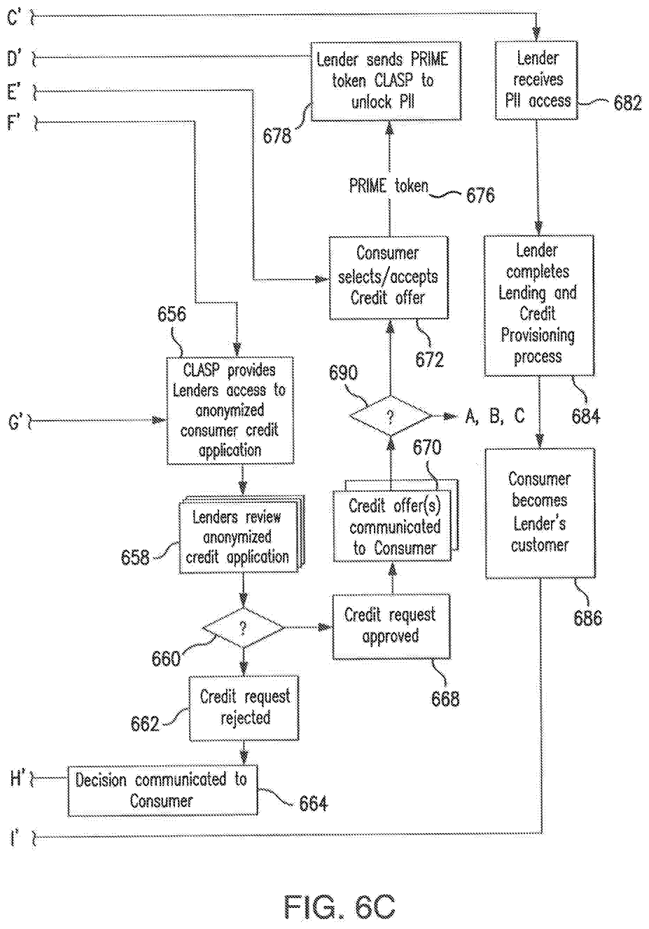

Method 500 may begin at a step 502 and proceed to a step 504. At step 504 (also indicated as “B”), user 120 may perform a world wide web search for credit on user device 130. As an example, user 120 may search for credit on Google.com, Bing.com, Safari.com, etc. As indicated at step 506, user 120 may be presented with one or more hits to the credit search of step 504. For example, user 120 may be presented with hits linking to market intermediaries (e.g., Lead Point, Lending Tree, Nerd Wallet), financial institutions 140, and/or other responsive sites. At step 508, user 120 is presented with offers of market intermediaries and/or financial institutions (noted in FIG. 5 as “lenders”), and, at step 510, user 120 selects at least one of the offers presented at step 508. At step 512, user 120 determines whether to create a preliminary request for credit. If user 120 determines not to create a preliminary request for credit, the method may proceed to an end step 578. If user 120 instead determines to create a preliminary request for credit, the preliminary request is sent to one or more of a market intermediary (as indicated at step 514) or a financial institution (as indicated at step 516). If the preliminary request is sent to market intermediary, the method 500 may proceed to step 516, which may be or include one or more steps depicted and/or described in reference to FIG. 6. If the preliminary request is instead sent to a financial institution (e.g., financial institution 140a), financial institution 140a may re-direct the request to CLASP 170. The re-directed request may include any information provided by user 120 that is associated with the preliminary request for credit.

Upon redirect, user 120 may provide personally identifiable information (PII) to CLASP 170 (as indicated at step 520). After providing this information, the method 500 may proceed to a step 522. At step 522, CLASP 170 receives credit information about user 170 based on the personally identifiable information provided by user 120 at step 520. In some embodiments, credit information is received due to a request sent from CLASP 170 credit sources 524. The credit information received at step 522 may be collected from credit bureaus (e.g., credit bureau 150), creditors (e.g., creditors 160), and/or any other suitable credit verification sources. After retrieving this information, the method 500 may proceed to a step 526. At step 526, CLASP ranks user 120. In some embodiments, the ranking (e.g., super prime, prime, sub-prime, etc.) of user 120 may be based on a credit score. Such credit score may be generated by CLASP 170 based on the information received at step 522. In some embodiments, the ranking assigned to user 120 reflects a status of user 120 relative to all users of CLASP 170. After ranking user 120, the method 500 proceeds to step 528. At step 528, CLASP 170 create an anonymized financial profile 220 and/or an anonymized credit application 240 associated with user 120. After creating the financial profile 220 and/or the credit application 240 associated with user 120, method 500 may proceed to step 530 wherein CLASP 170 notifies user 120 that his/her financial profile 220 and/or credit application 240 has been generated.

The method 500 may then proceed to a step 532 in which user 120 requests a token (depicted as PRIME #1) from CLASP 170 and, at step 534, CLASP 170 may send user 120 a token (PRIME #1) corresponding to the request. Upon receiving PRIME #1, the method 500 may proceed to a step 536 at which user 120 sends PRIME #1 to financial institution 140a.

As illustrated, financial institution 140a receives PRIME #1 at step 538. FIG. 5 depicts and describes two token flows that may occur at this point in method 500: an “A” flow whereby CLASP 170 authenticates PRIME #1; and a “B” flow whereby financial institution 140a authenticates PRIME #1. The “A” token flow begins at step 540a and involves financial institution 140a sending PRIME #1 and an access request to CLASP 170. The access request may include and/or be a request to access the financial profile 220 and/or the credit application 240 associated with user 120. In response to receiving PRIME #1 and the access request, CLASP 170 determines whether to grant the access request based on an authentication decision regarding PRIME #1. For example, if at step 542, CLASP 170 determines that PRIME #1 cannot be authenticated, the method 500 may proceed to end step 578. If however, at step 542A, CLASP 170 determines that PRIME #1 is authenticated, the method 500 may proceed to step 544. The “B” token flow begins at step 540B and involves financial institution 140a requesting an authentication token (illustrated as PRIME #2) from CLASP 170. In some embodiments, the requested token PRIME #2 may be used to authenticate PRIME #1. If financial institution 140a is successful in authenticating PRIME #1 with PRIME #2, the method 500 may proceed to step 544 at which time CLASP 170 provides financial institution 140a access to credit application 240.

Upon receiving access to credit application 240, financial institution 140a reviews credit application 240 to determine whether to approve the credit request of user 120 (see step 548). Following determination step 548, financial institution 140a either denies the credit application (see step 550) or approves the credit application (see step 556). If the credit application is denied, the method may proceed to step 552 wherein the credit decision is communicated to user 120. In some embodiments, financial institution 140a communicates the credit decision to user 120. In other embodiments, CLASP 170 communicates the credit decision to user 120. Following communication of the credit decision, the method 500 may proceed to step 554 in which user 120 may choose to return to step 504 and/or 508. Alternatively, user 120 may decide not to continue a credit request and, in that case, the method 500 may proceed to end step 578.

If the credit application is instead approved, the method 500 may proceed to a step 558 in which a credit offer of financial institution 140a is communicated to user 120. In some embodiments, financial institution 140a communicates the credit offer to user 120. In other embodiments, CLASP 170 communicates the credit offer to user 120. After communicating the credit offer, the method 500 may proceed to a determination step 560. At determination step 560, user 120 determines whether to accept or reject the credit offer. If at step 560, user 120 determines to reject the credit offer, the method 500 may proceed to step 504, 508, and/or end step 578 (as indicated by options “A, B, C”). Alternatively, user 120 may decide to accept credit offer (see step 562). In such case, the method 500 may proceed to step 564 in which user 120 requests and receives an additional token 250 (referred to in FIG. 5 as “PRIME token #2 or Prime #3) from CLASP 170. In some embodiments, this additional token may be used to access personally identifiable information (PII) of user 120. User 120 may then send the token (referred to in FIG. 5 as “PRIME #2 or Prime #3) to financial institution 140a (see step 566) which in turn sends a request for PII of user 120 and the token to CLASP 170 (see step 566). In some embodiments, CLASP 170 uses the received token to authenticate the request for PII. In some embodiments, such as the embodiment depicted in FIG. 500, CLASP 170 authenticates the token and grants financial institution 140a access to PII and/or additional information regarding user 120 (see step 570). Financial institution 140a then gains access to PII of user 120 (see step 572) and completes the application and lending process (see step 574). After completing the application and lending process, user 120 becomes a customer of financial institution 140a (see step 576) and the method 500 may proceed to end step 578.

FIG. 6 also illustrates a method 600 of securing sensitive data using CLASP 170. Generally, FIG. 6 illustrates a method flow wherein the credit application and lending process is initiated by a market intermediary (e.g., Lending Tree, Nerd Wallet). One or more steps of method 600 may overlap with steps of method 500. For example, steps 602, 604, 606, 608, 610, and 612 may correspond to steps 502, 504, 506, 508, 510, and 512, respectively of method 500. Additionally, steps 620, 622, 626, and 628 may correspond to steps 520, 522, 526, and 528 of method 500. Hereinafter, this disclosure describes the steps of method 600 that are different from the steps of method 500.

The method 600 may begin in a step 602 and continue as described above in reference to steps 502, 504, 506, 508, 510, and 512 of method 500. If at step 612, user 120 selects a credit offer associated with a financial institution (depicted as “lender”), web browser of user device 130 may be directed to a webpage associated with financial institution. Thereafter, the method 600 may proceed to step 616 which may include one or more of the steps of method 500. Alternatively, if at step 612 user 120 selects an offer associated with a market intermediary, web browser of user device 130 may be directed to a webpage associated with a market intermediary. Thereafter, the webpage of the market intermediary may redirect user 120 to CLASP 170 (see step 618). The method 600 may then proceed as described above in reference to steps 520, 522, 526, and 528 of method 500. After CLASP 170 has created one or more of financial profile 220 and/or credit application 240 associated with user 120, user 120 may request PRIME #1 from CLASP 170 (see step 630) and user 120 may receive PRIME #1 from CLASP 170 (see step 632). Upon receiving PRIME #1, user 120 may send PRIME #1 to the market intermediary (see step 634). The method 600 may then proceed to a step 636 in which the market intermediary receives PRIME #1 from user 120. After receiving PRIME #1 from user 120, the method 600 may proceed in either token flow “A” or token flow “B:” the “A” flow whereby CLASP 170 authenticates PRIME #1; and the “B” flow whereby market intermediary 180 authenticates PRIME #1. These flows are illustrated in FIG. 6 as steps 638, 640A, and 640B. Following token flow “A” or “B,” the market intermediary receives access to financial profile 220 and/or credit application 240 associated with user 120. At step 642, the market intermediary reviews the credit application 240 associated with user 120 and, at step 644, receives credit quotes from one or more financial institutions meeting the credit needs of user 120. At step 646, the market intermediary selects one or more financial institutions 140 corresponding to one or more credit quotes and requests, for each selected financial institution 140, a PRIME token from CLASP 170. At step 648, CLASP 170 sends the one or more requested PRIME tokens to the market intermediary. Thereafter, the market intermediary may send one of the requested PRIME tokens to each of the selected financial institutions 140 (see step 650) and, at step 652, each selected financial institution 140 receives a PRIME token from the market intermediary. At step 654, financial institutions 140 may send their respective PRIME tokens to CLASP 170 for authentication purposes, and in response to authenticating, CLASP 170 may grant financial institutions 140 access to one or more of financial profile 220 and/or credit application 240 associated with user 120 (see step 656). The method 600 may then proceed as described above in reference to steps 546, 548, 550, 552, 554, 556, 558, 560, 562, 564, 566, 568, 570, 572, 574, 576, and 578 (corresponding to steps 658, 660, 662, 664, 666, 668, 670, 690, 672, 674, 676, 678, 680, 682, 684, 686, and 688, respectively). The method 600 may end in end step 688.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the embodiments described or illustrated herein that a person having ordinary skill in the art would comprehend. The scope of this disclosure is not limited to the embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. A system for securing sensitive data, the system comprising:
one or more databases configured to store:
a plurality of financial profiles, each financial profile corresponding to a user of the system;
personally identifiable information corresponding to each user of the system;
at least one processor; and
a memory configured to store instructions, the instructions when executed by the processor are operable to: communicate a credit application associated with a first user to a third party, wherein the credit application is generated based on a financial profile corresponding to a first user but does not reveal personally identifiable information corresponding to the first user; and
in response to determining that the first user accepted a credit offer of the third party, automatically communicate, to the third party, the personally identifiable information corresponding to the first user.

2. The system of claim 1, wherein the instructions, when executed by the processor, are further operable to:
generate a first token corresponding to the first user, and
communicate the first token to the third party.

3. The system of claim 2, wherein the instructions, when executed by the processor, are further operable to:
in response to receiving the first token from the third party, provide the third party with access to one or more of:
the credit application associated with the first user; or
the personally identifiable information corresponding to the first user.

4. The system of claim 2, wherein the instructions, when executed by the processor, are operable to:
in response to receiving the token from the third party decrypt, using the token received from the third party, one or more of:
the credit application associated with the first user; or
the personally identifiable information corresponding to the first user.

5. The system of claim 1, wherein the third party is selected from the group comprising:
a financial institution;
a creditor;
a market intermediary.

6. The system of claim 1, wherein each financial profile is generated based on data received from credit sources.

7. The system of claim 6, wherein the credit source is one selected from the group consisting of:
a financial institution;
a creditor; and
a credit bureau.

8. The system of claim 1, wherein the personally identifiable information corresponding to the first user is provided by the user.

9. A method of securing sensitive data, the method comprising:
generating an anonymized credit application corresponding to a user based on a financial profile corresponding to the first user;
communicating the anonymized credit application to a third party;
in response to determining that the user accepted an offering associated with the third party, communicating, to the third party, personally identifiable information corresponding to the user.

10. The method of claim 9, further comprising:
generating a first token corresponding to the first user, and
communicating the first token to the third party.

11. The method of claim 9, further comprising:
in response to receiving the first token from the third party, providing the third party with access to one or more of:
the credit application associated with the first user; or
the personally identifiable information corresponding to the first user.

12. The method of claim 9, further comprising:
response to receiving the token from the third party, decrypting, using the token received from the third party, one or more of:
the credit application associated with the first user; or
the personally identifiable information corresponding to the first user.

13. The method of claim 9, wherein the third party is selected from the group comprising:
a financial institution;
a creditor;
a market intermediary.

14. The method of claim 9, wherein each financial profile is generated based on data received from one or more credit sources.

15. The method of claim 14, wherein the one or more credit sources comprise at least one of:
a financial institution;
a creditor; or
a credit bureau.

16. The method of claim 9, wherein the personally identifiable information corresponding to the first user is provided by the user.

17. One or more computer readable non-transitory storage media embodying software that is operable when executed to:
generate an anonymized credit application corresponding to a user based on a financial profile corresponding to the first user;
communicate the anonymized credit application to a third party;
in response to determining that the user accepted an offering associated with the third party, communicate, to the third party, personally identifiable information corresponding to the user.

18. The media of claim 17, further embodying software that is operable when executed to:
generate a first token corresponding to the first user, and
communicating the first token to the third party.

19. The media of claim 18, further embodying software that is operable when executed to:
in response to receiving the token from the third party, decrypt, using the token received from the third party, the credit application associated with the first user.

20. The media of claim 18, further embodying software that is operable when executed to:
in response to receiving the token from the third party, decrypt, using the token received from the third party, the personally identifiable information corresponding to the first user.
